(19) United States
(12) Patent Application Publication
(10) Pub. No.: US 2026/0160619 A1
(43) Pub. Date: Jun. 11, 2026

(54) METHOD FOR DETERMINING A TORQUE AND A DRIVE SHAFT ANGLE

(71) Applicant: Schaeffler Technologies AG & Co. KG, Herzogenaurach (DE)

(72) Inventor: Kazuaki Kaneko, Yokohama (JP)

(21) Appl. No.: 18/879,649

(22) PCT Filed: Jun. 12, 2023
(86) PCT No.: PCT/DE2023/100438

§ 371 Date: Dec. 27, 2024

(30) Foreign Application Priority Data
Jun. 29, 2022 (DE) 10 2022 116 180.3

(51) Int. Cl. G01L 3/10; G01B 7/30; G01D 5/14; G01L 5/00

(52) U.S. Cl. CPC G01L 3/108; G01B 7/30; G01D 5/145; G01L 5/0061

(57) ABSTRACT

The present invention relates to a method for determining a torque (T) and a drive shaft angle (A) of a gear mechanism (1). The method can comprise determining a first measurement signal by means of a torque sensor (2) integrated in the gear mechanism (1). The method can further comprise determining a second measurement signal by means of a Hall sensor (3) integrated in the gear mechanism (1). The method can, in a further step, comprise determining the torque (T) from the first measurement signal. In a further step, the method can include determining the drive shaft angle (A) from the second measurement signal. The method can further comprise transmitting a data set (D), comprising the torque (T) and the drive shaft angle (A), by means of a single communication line (4) to a component (5) arranged outside the gear mechanism (1). The present invention furthermore relates to a gear mechanism (1), comprising a torque sensor (2) integrated in the gear mechanism (1), a Hall sensor (3) integrated in the gear mechanism (1) and communication lines (4).

### CROSS-REFERENCE TO RELATED APPLICATION

The present application is the U.S. National Phase of PCT Patent Application Number PCT/DE2023/100438, filed on Jun. 12, 2023, which claims priority to German Patent Application Number 10 2022 116 180.3, filed Jun. 29, 2022, the entire disclosures of which are incorporated by reference herein.

### TECHNICAL FIELD

The present disclosure relates generally to the technical field of methods for determining a torque and a drive shaft angle of a gear mechanism.

### BACKGROUND

Methods for determining a torque and a drive shaft angle have many uses in the field of gear mechanism technology. For example, the torque and drive shaft angle are measured or mathematically determined to improve a gear mechanism in the robotics field. In particular, industrial robots and multi-jointed robot joint systems often require a high torque and the instantaneous drive shaft angle of a gear mechanism to ensure optimal movement of the multi-jointed robot joint system for the specific use. In addition to the robotics field, torque and drive shaft angle are also important parameters in automotive engineering.

A gear mechanism typically comprises a drive shaft leading into the gear mechanism.

To determine the torque, a torque sensor is usually connected to a robot joint controller. Such a torque sensor is generally formed by attaching strain gauges to a component of the gear mechanism of the robot joint system and by determining a torque on the basis of input data, wherein the input data is measured by the strain gauges. Such methods are described, for example, in the following scientific publications:

Hashimoto, Minoru, Yoshihide Kiyosawa, and Richard P. Paul. “A torque sensing technique for robots with harmonic drives.” IEEE Transactions on Robotics and Automation 9.1 (1993): 108-116.

Hashimoto, Minoru, and Yoshihide Kiyosawa. “Experimental study on torque control using Harmonic Drive built-in torque sensors.” Journal of Robotic Systems 15.8 (1998): 435-445.

To determine the drive shaft angle, a Hall sensor is usually connected to the robot joint controller. The Hall sensor is positioned near the drive shaft, wherein a magnet is arranged on the drive shaft. Due to the rotation of the drive shaft and the magnet, a magnetic flux density can be measured using the Hall sensor. The drive shaft angle, i.e., the instantaneous angle of rotation of the drive shaft, can be calculated from the magnetic flux density.

For robot joint controllers that communicate both with a Hall sensor and a torque sensor, different communication protocols, electrical connections and wiring must be used for the two sensors. The specifications for guaranteed operating temperature, certified security level, sampling frequency and IP (waterproof) level may also differ between these two sensors, resulting in more development effort to ensure they function properly and maintain a high product quality.

It is therefore an object of the present disclosure to provide an improved method for determining a torque and a drive shaft angle of a gear mechanism, thereby overcoming at least in part the above-mentioned disadvantages of the prior art. A further object of the present disclosure is to provide an improved gear mechanism.

### SUMMARY

These objects are achieved by the features of the independent claims. In its most general form, the disclosure relates to a method for determining a torque and a drive shaft angle of a gear mechanism. The method may comprise determining a first measurement signal by means of a torque sensor integrated in the gear mechanism. Furthermore, the method may comprise determining a second measurement signal by means of a Hall sensor integrated in the gear mechanism. In a further step, the method may comprise determining the torque from the first measurement signal. In a further step, the method may comprise determining the drive shaft angle from the second measurement signal. The method may further comprise transmitting a data set comprising the torque and the drive shaft angle, by means of a single communication line, to a component arranged outside the gear mechanism.

The gear mechanism is preferably part of a vehicle or robot. The gear mechanism can be connected to a motor. The motor can be an internal combustion engine, an electric motor, a fuel cell, a hybrid drive or another type of energy converter.

The torque can be understood as the torque available for driving the vehicle, the robot or a manipulator link of the robot. Torque can be understood as the torque applied to a drive shaft of the gear mechanism. For example, the torque of the gear mechanism can be the output torque of the gear mechanism. The torque of the gear mechanism can be transmitted directly to the wheels of the vehicle.

The drive shaft angle typically refers to the angle of rotation of the drive shaft leading into the gear mechanism. For example, the drive shaft can initially have a drive shaft angle of approximately 0°. After half a revolution of the drive shaft, the drive shaft angle is substantially 180°. The direction of rotation refers to the direction of rotation of the drive shaft. The direction of rotation can be clockwise or counterclockwise.

“Determining the torque and/or determining the drive shaft angle” is typically understood by the person skilled in the art to mean any kind of determination and/or calculation in the mathematical sense. Any type of mathematical operation can be used for this purpose, in particular iterative methods. Reading from tables can also be used for determining the torque and/or determine the drive shaft angle. The torque and/or the drive shaft angle can also be determined using a mathematical model.

Determining the torque and/or determining the drive shaft angle can be implemented on a microcontroller integrated in the gear mechanism. An advantage of this implementation is that the method steps can be carried out entirely on the microcontroller and no additional components are necessary.

The torque sensor may comprise a strain gauge. The strain gauge can consist of a semiconductor and measure a voltage applied to a resistor based on the piezoresistive effect.

The Hall sensor can be designed as a single-axis or two-axis Hall sensor. The Hall sensor can have a typical design. Typical designs can be rectangular, butterfly or cross shaped.

The first measurement signal can be a voltage detected by the torque sensor. Furthermore, the second measurement signal can be a magnetic flux density detected by the Hall sensor.

A communication line can be a standard communication system or a component of a communication system. Communication systems can, for example, be EtherCAT, RS485 or SPI bus systems. Communication between the two sensors, i.e., the torque sensor and the Hall sensor, and a component arranged outside the gear mechanism can advantageously take place via a bus or a line. Furthermore, no complicated cabling is necessary between the two sensors and the component. Furthermore, the torque and drive shaft angle can be sent simultaneously via the communication line.

A component arranged outside the gear mechanism can be, for example, a motor controller or a robot joint controller. The motor controller or robot joint controller can also be designed to control the motor and/or other components. The motor controller or robot joint controller can, for example, regulate the speed of a manipulator link of a robot or the speed of a vehicle. This kind of closed-loop control can be realized here using a control loop implemented as an algorithm.

The gear mechanism types that can be used are spur gear mechanisms, bevel gear mechanisms, helical gear mechanisms, planetary gear mechanisms or strain wave gear mechanisms.

Some or all of the method steps can be carried out by (or using) a hardware device, such as by a microcontroller. It is also possible that the hardware device comprises a processor, a microprocessor, a programmable computer or an electronic circuit. In some exemplary embodiments, one or more of the key method steps can be carried out by such a device.

Naturally, the method can be fully automated. It is also possible for the method to be carried out continuously in real time, as is common in the field of robotics or motor technology.

The method according to the disclosure advantageously leads to an improvement in the communication between the torque sensor or Hall sensor integrated in the gear mechanism and the components arranged outside the gear mechanism. The method leads to an improved, simpler structure and lower production costs of the gear mechanism.

In a further aspect of the disclosure, the data set is transmitted using a single communication protocol. The communication protocol can be, for example, an EtherCAT, RS485 or SPI protocol.

In a further aspect of the disclosure, the drive shaft angle is determined by means of the Hall sensor integrated in the gear mechanism and by means of a ring magnet integrated in the gear mechanism. The ring magnet can be designed as a permanent magnet. One half of the ring magnet can be designed as a positive pole and the other half of the ring magnet as a negative pole.

In a further aspect of the disclosure, the second measurement signal comprises a magnetic flux density. The drive shaft angle can be determined from the magnetic flux density by means of a mathematical model, preferably by means of a regression model, particularly preferably by means of a non-linear regression model. The mathematical model can also be a radial basis function (RBF).

In a further aspect of the disclosure, a sensor system is provided which comprises means for carrying out one of the methods described herein.

The sensor system may comprise a torque sensor and a Hall sensor. Furthermore, the sensor system may comprise a microcontroller and/or a storage medium (or data carrier or computer readable medium) comprising a computer program stored thereon for executing one of the methods described herein when executed by a processor. The data carrier, the digital storage medium or the recorded medium are usually tangible and/or non-transitory. A further exemplary embodiment of the present disclosure is a sensor system, as described herein, comprising a processor and the storage medium.

In a further aspect of the disclosure, a computer program is provided, comprising commands which, when the program is executed by a computer, cause the computer to carry out one of the methods described herein.

According to the disclosure, a gear mechanism is also provided. The gear mechanism can comprise a torque sensor integrated in the gear mechanism, a Hall sensor integrated in the gear mechanism and communication lines. Furthermore, the gear mechanism can be designed in such a way that a data set from the torque sensor integrated in the gear mechanism and the Hall sensor integrated in the gear mechanism can be transmitted, by means of a single communication line, to a component arranged outside the gear mechanism.

The gear mechanism according to the disclosure can advantageously have a particularly space-saving and compact design. The gear mechanism can also advantageously have a small number of components.

In a further aspect of the disclosure, the gear mechanism comprises a ring magnet integrated in the gear mechanism.

In a further aspect of the disclosure, the gear mechanism comprises an analog-digital converter integrated in the gear mechanism. The gear mechanism may further comprise a microcontroller integrated in the gear mechanism. It is also possible that the gear mechanism comprises a circuit board integrated in the gear mechanism.

Artificial neural networks can be used as mathematical models of the methods described herein.

Artificial neural networks (ANN) are systems inspired by biological neural networks, such as those found in a retina or a brain. ANNs comprise a plurality of interconnected nodes and a plurality of connections, so-called edges, between the nodes. There are usually three types of nodes, input nodes that receive input values, hidden nodes that are (only) connected to other nodes, and output nodes that provide output values. Every node can represent an artificial neuron. Every edge can send information from one node to another. The output of a node can be defined as a (non-linear) function of the inputs (for example the sum of its inputs). The inputs of a node can be used in the function based on a “weight” of the edge or node providing the input. The weight of nodes and/or edges can be adjusted as part of a learning process. In other words, training an artificial neural network can comprise adjusting the weights of the nodes and/or edges of the artificial neural network, i.e., in order to achieve a desired output for a certain input.

Alternatively, the mathematical model can be a support vector machine, a random forest model or a gradient boosting model. Support vector machines (i.e., support vector networks) are supervised learning models with associated learning algorithms that can be used to analyze data (for example in a classification or regression analysis). Support vector machines can be trained by providing an input with a plurality of training input values belonging to one of two categories. The support vector machine can be trained in order to assign a new input value to one of the two categories. Alternatively, the mathematical model can be a Bayesian network, which is a probabilistic-directed, acyclic graphical model. A Bayesian network can represent a set of random variables and their conditional dependencies using a directed acyclic graph. Alternatively, the mathematical models can be based on a genetic algorithm, which is a search algorithm and heuristic technique that mimics the process of natural selection.

The mathematical models can be trained using a training data set or can be pre-trained. The training data set can be created on a test bench, for example. The signals required for the training data set can be measured on the test bench using the torque sensor and Hall sensor.

For example, “supervised learning” can be used as the training method for the mathematical models. In supervised learning, the mathematical models are trained using a plurality of training sample values, wherein each sample value can comprise a plurality of input data values and a plurality of desired output values, i.e., each training sample value is associated with a desired output value. By specifying both training sample values and desired output values, the machine learning model “learns” which output value is to be provided based on an input sample value that is similar to the sample values provided as part of the training. In addition to supervised learning, semi-supervised learning can also be used. In semi-supervised learning, some of the training sample values are missing a desired output value. Supervised learning can be based on a supervised learning algorithm (for example a classification algorithm, a regression algorithm or a similarity learning algorithm). Classification algorithms can be used when the outputs are restricted to a limited set of values (categorical variables), i.e., the input is classified as one value of the limited set of values. Regression algorithms can be used if the outputs show any numerical value (within a range). Similarity learning algorithms can be similar to both classification and regression algorithms, but are based on learning from examples using a similarity function that measures how similar or related two objects are. In addition to supervised learning or semi-supervised learning, unsupervised learning can be used in order to train the machine learning model. In unsupervised learning, (only) input data may be provided and an unsupervised learning algorithm can be used to find a structure in the input data (for example by grouping or clustering the input data, finding commonalities in the data). Clustering is the assignment of input data comprising a plurality of input values into subsets (clusters) so that input values within the same cluster are similar according to one or more (predefined) similarity criteria, while they are dissimilar to input values comprised in other clusters.

### BRIEF DESCRIPTION OF THE DRAWINGS

Preferred embodiments of the present disclosure are described below with reference to the following figures:

FIG. 1: shows a gear mechanism 1 according to embodiments of the disclosure.

FIG. 2: shows a method according to embodiments of the disclosure in an overview.

FIG. 3A: shows a cut-out of the gear mechanism 1 with a ring magnet 11 according to an embodiment of the disclosure.

FIG. 3B: shows a ring magnet 11 according to an embodiment of the disclosure.

FIG. 4: shows a gear mechanism 1 in a side view according to an embodiment of the disclosure.

FIG. 5: shows signals detected by means of the Hall sensor 3 and methods for determining the drive shaft angle A according to an embodiment of the disclosure.

### DESCRIPTION OF PREFERRED EXEMPLARY EMBODIMENTS

The following describes embodiments of the disclosure in which a method for determining a torque and a drive shaft angle of a gear mechanism is used in order to make the gear mechanism particularly efficient and compact.

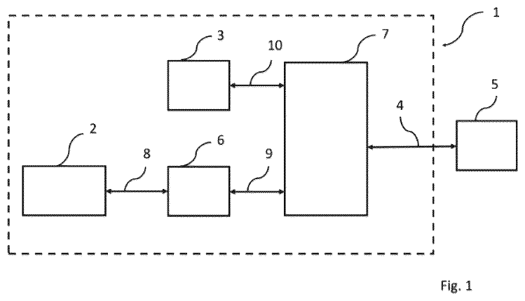

FIG. 1 shows a gear mechanism 1 according to an embodiment of the disclosure. In the example shown, the gear mechanism 1 is used in an industrial robot and comprises a torque sensor 2 integrated in the gear mechanism 1 and a Hall sensor 3 integrated in the gear mechanism 1.

The gear mechanism 1 is a strain wave gear (SWG) with an elastic gear mechanism element that is characterized by a high gear mechanism ratio and rigidity. The elastic gear mechanism element is also referred to as a flexspline. The gear mechanism 1 also has a drive shaft and an output shaft. The torque of the output shaft is passed on to a manipulator of the industrial robot.

The torque sensor 2 comprises a strain gauge, wherein the strain gauge consists of a semiconductor and measures a voltage applied to a resistor on the basis of the piezoresistive effect. Here, a change in resistance and voltage is caused by a deformation of the strain gauge. The advantage of the used strain gauge compared to conventional metal strain gauges is its high sensitivity. The strain gauge of the torque sensor 2 is arranged on an elastic gear mechanism element of the gear mechanism 1. The torque sensor 2 is thus embedded in the gear mechanism 1.

A first measurement signal detected by the torque sensor 2 is transmitted to an analog-digital converter 6 in the form of an analog signal via an analog line 8. In the analog-digital converter 6, the first measurement signal is translated from an analog signal into a digital signal.

The first measurement signal detected by the torque sensor 2 is transmitted in the form of a digital signal, via a first line 9, from the analog-digital converter 6 to a microcontroller 7. Furthermore, a second measurement signal detected by the Hall sensor 3 is transmitted, via a second line 10, to the microcontroller 7.

The first line 9 is a serial peripheral interface (SPI) system. The second line 10 is an inter-integrated circuit (I2C) system.

The microcontroller 7 is integrated in the gear mechanism 1. Computer-aided calculations are carried out using the microcontroller 7. A torque is calculated from the first measurement signal detected by the torque sensor 2. Furthermore, a drive shaft angle is calculated from the second measurement signal detected by the Hall sensor 3. Finally, the torque and the drive shaft angle are combined into one data set using the microcontroller 7.

The gear mechanism 1 is connected to a motor controller 5 arranged outside the gear mechanism by means of a single communication line 4. The communication line 4 is an EtherCAT system. The data set, comprising the torque and the drive shaft angle, is thus transmitted from the gear mechanism 1 to the motor controller 5.

In the motor controller 5, the torque and the drive shaft angle can be used for further calculations.

All calculation times are within a typical range for robotics applications. All calculations and signal gear mechanisms meet the real-time requirements of industrial robots.

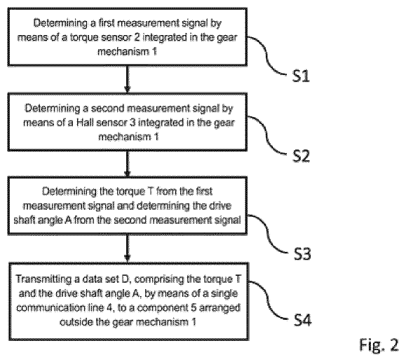

FIG. 2 shows a method according to an embodiment of the disclosure in a schematic representation. The method according to the embodiment comprises the following steps:
First step S1: Determining a first measurement signal by means of a torque sensor 2 integrated in the gear mechanism 1.
Second step S2: Determining a second measurement signal by means of a Hall sensor 3 integrated in the gear mechanism 1.
Third step S3: Determining the torque T from the first measurement signal and determining the drive shaft angle A from the second measurement signal.
Fourth step S4: Transmitting a data set D, comprising the torque T and the drive shaft angle A, by means of a single communication line 4, to a component 5 arranged outside the gear mechanism 1.

It is understood that the sequence of the steps S1, S2, S3 and S4 mentioned may vary depending on the application. For example, the second measurement signal can first be determined by means of a Hall sensor 3 integrated in the gear mechanism 1 and then the first measurement signal can be determined by means of a torque sensor 2 integrated in the gear mechanism 1. Simultaneous execution of the first step S1 and the second step S2 is also possible.

After the data set D has been transmitted, the torque T and the drive shaft angle A can be used for further calculations in the component 5 in a further step not shown in the embodiment.

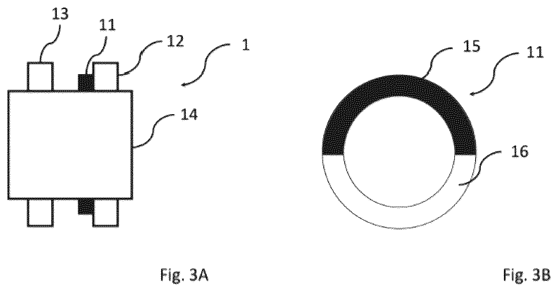

FIG. 3A shows a cut-out of the gear mechanism 1 with a ring magnet 11 according to an embodiment of the disclosure. The gear mechanism 1 comprises a bearing 12, a seal 13 and a drive shaft 14. The ring magnet 11, the bearing 12 and the seal 13 are arranged on the drive shaft 14. The ring magnet 11 is arranged next to the bearing 12. The ring magnet 11 is designed as a permanent magnet.

FIG. 3B shows a ring magnet 11 according to an embodiment of the disclosure. The ring magnet 11 is designed as a permanent magnet and has a negative pole 15 and a positive pole 16. When the ring magnet 11 rotates with the drive shaft 14, the magnetic field around the gear mechanism shaft 14 changes. A radially spaced, fixed sensor, such as a Hall sensor, can detect the magnetic flux density.

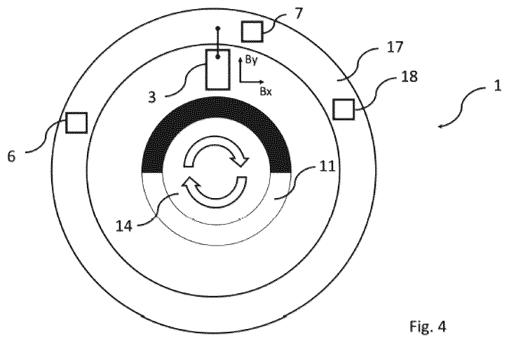

FIG. 4 shows the gear mechanism 1 in a side view according to an embodiment of the disclosure. The gear mechanism 1 comprises a circuit board 17. The analog-digital converter 6 and the microcontroller 7 are arranged on the circuit board 17. Furthermore, a communication unit 18 is arranged on the circuit board 17. Components of an EtherCAT, RS485 or SPI system can be used as communication unit 18. The Hall sensor 3 is connected to the circuit board 17.

The rotation of the ring magnet 11 with the gear mechanism shaft 14 generates a changing magnetic field. The Hall sensor 3 detects the magnetic flux density with the coordinates Bx and By.

The data set D can be stored in a buffer on the circuit board 17. The microcontroller 7 first receives the first measurement signal from the torque sensor 2 and the second measurement signal from the Hall sensor 3 and calculates the drive shaft angle A and the torque T. The microcontroller 7 stores the calculation result in the buffer in each calculation cycle (e.g., with a frequency of 5 kHz).

The data set D can be transferred to the components 5 in further steps and further processed using the component 5. Advantageously, no additional coder or encoder is required in the component 5 for further processing of the data set D. The torque T and the drive shaft angle A can, for example, be transmitted to a control loop. In this regard, the control loop can be provided to control a motor and/or a speed. The control loop can also be designed to control a torque. Advantageously, a closed-loop control based on the control loop can thus be improved.

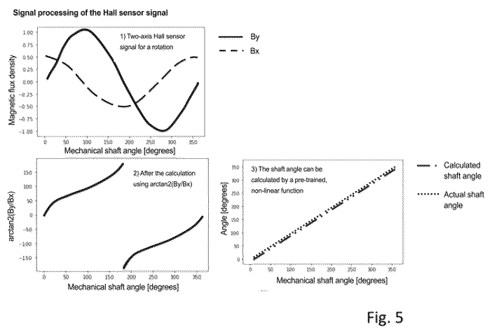

FIG. 5 shows measurement signals detected by the Hall sensor 3 and methods for determining the drive shaft angle A according to an embodiment of the disclosure. The drive shaft angle A is determined from the magnetic flux density with the coordinates Bx and By.

The second measurement signal is recorded in the form of the magnetic flux density with the coordinates Bx and By using the Hall sensor 3. The signal Y is then calculated using the coordinates Bx and By of the magnetic flux density:

$$Y = {arctan}^{2} ( B x / B y ) ,$$

where arctan²( ) is the squared arctangent function.

In a further step, the drive shaft angle A is determined from the signal Y using a mathematical model f( ):

$$A = f ( Y ) ,$$

where the mathematical model f( ) is a non-linear regression model. The mathematical model f( ) was trained in advance using a training data set and conventional machine learning methods. The determination of the drive shaft angle A takes place on the microcontroller 7.

In addition to their use in robotics and passenger cars, the principles disclosed here can also be implemented in other areas of application, e.g., in lorries, trucks, motorcycles, axle drives and drives in flight simulators.

The algorithms or computer programs required for the above functions can expediently be implemented in whole or in part in the microcontroller 7, torque sensor 2, Hall sensor 3 and/or in another computer system connected to these devices. The computer system can be a local computer device (for example a personal computer, laptop, tablet computer, or cell phone) having one or more processors and one or more storage devices, or can be a distributed computer system (for example a cloud computing system having one or more processors or one or more storage devices distributed at various locations, for example, at a local client and/or one or more remote server farms and/or data centers).

Depending on certain implementation requirements, exemplary embodiments of the disclosure can be implemented using hardware or software. Some or all of the method steps can be carried out by (or using) a hardware device, such as a processor, a microprocessor, a programmable computer or an electronic circuit.

Although some aspects have been described in the context of a device, it is clear that these aspects also constitute a description of the corresponding method, wherein a block or device corresponds to a method step or a function of a method step. Similarly, aspects described in the context of a method step also represent a description of a corresponding block or element or a property of a corresponding device.

1. A method for determining a torque and a drive shaft angle of a gear mechanism, wherein the method comprises:
determining a first measurement signal by means of a torque sensor integrated in the gear mechanism;
determining a second measurement signal by means of a Hall sensor integrated in the gear mechanism;
determining the torque from the first measurement signal and determining the drive shaft angle from the second measurement signal; and
transmitting a data set comprising the torque and the drive shaft angle, by means of a single communication line, to a component arranged outside the gear mechanism.

2. The method according to claim 1, wherein the data set is transmitted by means of a single communication protocol.

3. The method according to claim 1, wherein the drive shaft angle is determined by means of the Hall sensor integrated in the gear mechanism and by means of a ring magnet integrated in the gear mechanism.

4. The method according to claim 1, wherein the second measurement signal comprises a magnetic flux density and wherein the drive shaft angle is determined from the magnetic flux density by means of a mathematical model, preferably by means of a regression model, particularly preferably by means of a non-linear regression model.

5. A sensor system, comprising means for executing the method according to claim 1.

6. A computer program, comprising commands which, when the program is executed by a computer, cause the computer to carry out the method according to claim 1.

7. A gear mechanism comprising a torque sensor integrated in the gear mechanism, a Hall sensor integrated in the gear mechanism and communication lines, wherein the gear mechanism is designed such that a data set from the torque sensor integrated in the gear mechanism and the Hall sensor integrated in the gear mechanism can be transmitted, by a single communication line, to a component arranged outside the gear mechanism.

8. The gear mechanism according to claim 7, wherein the gear mechanism comprises a ring magnet integrated in the gear mechanism.

9. The gear mechanism according to claim 7, wherein the gear mechanism comprises an analog-digital converter integrated in the gear mechanism, a microcontroller integrated in the gear mechanism and/or a printed circuit board integrated in the gear mechanism.

10. A system comprising:
a torque sensor integrated within a gear mechanism;
a magnetic flux sensor integrated within the gear mechanism;
a ring magnet integrated within the gear mechanism;
a controller coupled to the torque sensor and the Hall sensor, wherein the controller includes one or more processors configured to execute a computer program stored in a storage medium, wherein the computer program is configured to cause the one or more processors to:
receive data from the torque sensor;
receive data from the magnetic flux sensor;
determine a first measurement signal based on the data from the torque sensor;
determine a second measurement signal based on the data from the magnetic flux sensor;
determine the torque from the first measurement signal and determine the drive shaft angle from the second measurement signal; and
transmit a data set comprising the torque and the drive shaft angle to a component arranged outside the gear mechanism.

11. The system according to claim 10, the second measurement signal comprises a magnetic flux density, wherein the drive shaft angle is determined based on the magnetic flux density.

12. The system according to claim 11, wherein the drive shaft angle is determined based on the magnetic flux density via a model.

13. The system according to claim 12, wherein the model comprises at least one of a regression model or a radial basis function.

14. The system according to claim 10, wherein the magnetic flux sensor comprises a Hall sensor.

15. The system according to claim 10, wherein the ring magnet comprises a permanent magnet.

16. The system according to claim 10, wherein the data set is transmitted outside of the gear mechanism via a single communication line.

17. The system according to claim 10, further comprising analog-digital converter integrated in the gear mechanism.

18. The system according to claim 10, wherein the controller is integrated within the gear mechanism.

19. The system according to claim 10, further comprising a printed circuit board integrated in the gear mechanism.

20. The system according to claim 10, wherein the torque and the drive shaft angle are transmitted to a control loop to control at least one of a motor, a speed, or a torque.
